(19) United States
(12) Patent Application Publication
(10) Pub. No.: US 2021/0086305 A1
(43) Pub. Date: Mar. 25, 2021

(54) DEBURRING DEVICE

(71) Applicant: FANUC CORPORATION, Yamanashi (JP)

(72) Inventor: Atsushi MORI, Yamanashi (JP)

(73) Assignee: FANUC CORPORATION, Yamanashi (JP)

(21) Appl. No.: 17/025,231

(22) Filed: Sep. 18, 2020

(30) Foreign Application Priority Data
Sep. 25, 2019 (JP) 2019-173745

(51) Int. Cl. B23K 26/361

(52) U.S. Cl. CPC B23K 26/361

(57) ABSTRACT

An object is to provide a technology in which in debarring machining on a three-dimensionally shaped ridge line by laser application, a stable gas flow can be supplied and in which stable deburring machining can be performed. A deburring device for removing a burr which is present on a ridge line of a workpiece after being machined, includes: a laser device which includes a laser machining head that applies laser light to the ridge line; a transport device which transports the laser device and a gas jetting, device; and a controller which controls the laser device, the gas jetting device and the transport device and the controller controls the gas jetting device and the transport device such that a gas jetting nozzle is moved on a plane including the bisector of an apex angle of the ridge line and the ridge line and that in a side view parallel to the ridge line, an angle formed by the ridge line and the central axis line of the gas jetting, nozzle is an acute angle.

This application is based on and claims the benefit of priority from Japanese Patent Application No. 2019-173745, filed on 25 Sep. 2019, the content of which incorporated herein by reference.

### BACKGROUND OF THE INVENTION

### Field of the Invention

The present invention relates to deburring devices.

### Related Art

Conventionally, when cutting or the like is performed on a workpiece such as a metal, burrs are produced on a three-dimensionally shaped ridge line. This is also true for a case where a workpiece is a nonmetal and a case where a machining method is machining using a mold of casting, forging, powder sintering or the like or is another type of machining of pressing, laser or the like.

Since burrs cause various problems in a post-process, it is necessary to remove them. Hence, various proposals for removing burrs with laser are made (see, for example, Patent Documents 1 to 3).

When laser light is applied to burrs left on a three-dimensionally shaped ridge line so as to crush the burrs by melting, sublimation and thermal shock, since a molten material, vapors and crushed pieces generated at a machining point block the laser light, it is necessary to efficiently remove the burrs. In the middle of removing burrs, the burrs may be adhered to a workpiece again, and thus it is necessary to provide an ingenious idea for a method of removing the burrs.

In general laser machining, a gas such as air which is called an assist gas is sprayed to a machining point. In laser cutting, the purpose thereof is to remove a molten material with an assist gas flow, and in laser welding, the purpose thereof is to maintain a keyhole and remove an evaporated metal and the like from a laser light path and to prevent unfavorable reactions such as reactions of a molten metal with water, oxygen, nitrogen and the like.

Patent Document 1: PCT International Publication No. WO09-157319

### Patent Document 2: Japanese Unexamined Patent Application, Publication No. 2009-066851

### Patent Document 3: Japanese Unexamined Patent Application, Publication No. 2008-173652

### SUMMARY OF THE INVENTION

However, deburring machining is machining on a three-dimensionally shaped ridge line, and the flow of an assist gas in the vicinity of a machining point is complicated. A target of deburring machining often includes, in the position of a ridge line, the angle of a plane forming the ridge line and the like, a large number of errors from a geometric shape in design. The flow of the assist gas is very important in laser machining, and in deburring machining by laser application which is machining on a ridge line, the stable supply and flow of the assist gas are needed in order to real e stable machining.

Hence, a technology is desired in which in deburring machining on a three-dimensionally shape ridge line by laser application, a stable gas flow can be supplied and in which stable deburring machining can be performed.

An aspect of the present disclosure is a deburring device for removing, a burr which is present on a three-dimensionally shaped ridge line after machining, the deburring device includes: a laser device which includes a laser machining head that applies laser light to the three-dimensionally shaped ridge line; a gas jetting device which includes a gas jetting nozzle that jets an assist gas; a transport device which transports the laser device and the gas jetting device; and a controller which controls the laser device, the gas jetting device and the transport device and the controller controls the gas jetting device and the transport device such that the gas jetting nozzle is moved on a plane including the bisector of an apex angle of the ridge line and the ridge line and that in a side view parallel to the ridge line, an angle formed by the ridge line and a central axis line of the gas jetting nozzle is an acute angle.

Another aspect of the present disclosure is a deburring device for removing a burr which is present on a three-dimensionally shaped ridge line after machining, the deburring device includes: a laser device which includes laser machining head that applies laser light to the three-dimensionally shaped ridge line; a gas jetting device which includes a pair of gas jetting nozzles that jet an assist gas; a transport device which transports the laser device and the gas jetting device; and a controller which controls the laser device, the gas jetting device and the transport device and the controller controls the gas jetting device and the transport device such that the pair of gas jetting nozzles are moved while positions symmetrical to each other with respect to a plane including the bisector of an apex angle of the ridge line and the ridge line are being retained and that in a side view parallel to the ridge line, angles formed by the ridge line and the central axis lines of the pair of gas jetting nozzles are acute angles.

According to the present disclosure, in deburring machining on a three-dimensionally shaped ridge line laser application, a stable gas flow can be supplied, and stable deburring machining can be performed.

### BRIEF DESCRIPTION OF THE DRAWINGS

FIG. 1 is a diagram showing the configuration of a deburring device according to a first embodiment;

FIG. 2A is a side view showing the configuration of a laser machining head in the deburring device according to the first embodiment;

FIG. 2B is a side view showing the configuration of a laser machining head in a deburring device according to a variation of the first embodiment;

FIG. 3 is a side view showing the configuration of a gas jetting device in the deburring device according to the first embodiment;

FIG. 4 is a perspective view showing laser application using the deburring device according to the first embodiment;

FIG. 5 is a front view showing the laser application using the deburring device according to the first embodiment;

FIG. 6 is a front view showing the laser application using the deburring device according to the first embodiment;

FIG. 7 is a plan view showing the configuration of a gas jetting device in a deburring device according to a second embodiment;

FIG. 8 is a side view showing the configuration of the gas jetting device in the deburring device according to the second embodiment;

FIG. 9 is a front view showing laser application using the deburring device according to the second embodiment; and

FIG. 10 is a front view showing the laser application using the deburring device according to the second embodiment.

### DETAILED DESCRIPTION OF THE INVENTION

Embodiments of the present invention will be described in detail below with reference to drawings. In the description of a second embodiment, the same configurations as in a first embodiment are identified with the same reference numerals, and the description thereof will be omitted.

### First Embodiment

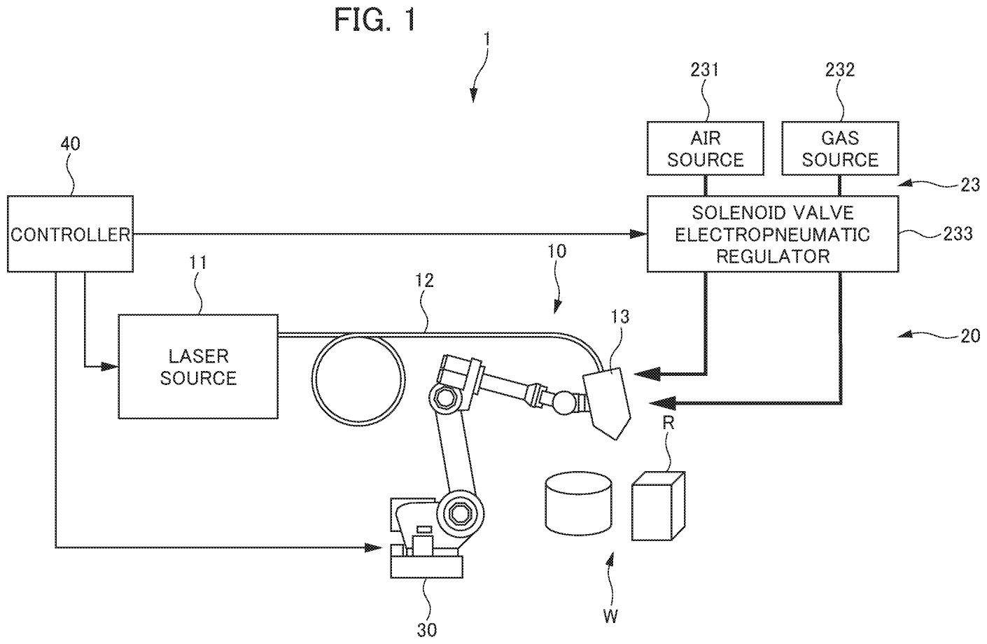

FIG. 1 is a diagram showing the configuration of a deburring device 1 according to the first embodiment. The deburring device 1 according to the present embodiment is a device for removing burrs which are present on a ridge line R of a workpiece W (three-dimensional shape) after being machined. As shown in FIG. 1, the deburring device 1 according to the present embodiment includes a laser device 10, a gas jetting device 20, a transport device 30 and a controller 40.

The workpiece W is a workpiece which has been machined and molded by cutting, turning, forging, casting, laser cutting, pressing, powder sintering or the like. The workpiece W is typically a workpiece in which an unintended surplus material (burr) is present on the ridge line R of a boundary between surfaces in a three-dimensional shape due to uncut portions or the like. The material of the workpiece W is not limited, and a workpiece formed of a metal, a resin, an inorganic material or another material can be used.

The ridge line R of the workpiece W on which burrs are produced is formed with apexes generated by coupling two surfaces to each other in the shape of a mountain. The ridge line R is not limited to a linear ridge line, and includes a curved ridge line. The deburring device 1 according to the present embodiment can remove burrs present on the ridge line R.

The laser device 10 includes a laser source 11, a light guide optical fiber 12 and a laser machining head 13.

The laser source 11 generates laser light, and various types are present. Examples thereof include a fiber laser, a DDL (direct diode laser), a diode laser, a YAG laser, a CO₂ laser and the like. In addition, a laser which has a high output and a high brightness can be used as the laser source. In the laser source 11, the application timing and the output thereof and the like are controlled by the controller 40 which will be described later.

The light guide optical fiber 12 guides the laser light generated in the laser source 11 to the laser machining head 13 which will be described later. In the light guide of the laser light, an optical mirror and the like which are not shown are also used as necessary.

As shown in FIG. 1, the laser machining head 13 is grasped with a hand at a tip of the arm of a robot serving as the transport device 30 which will be described later. In this way, it is possible to apply the laser light to a desired position of the workpiece W so as to perform scanning.

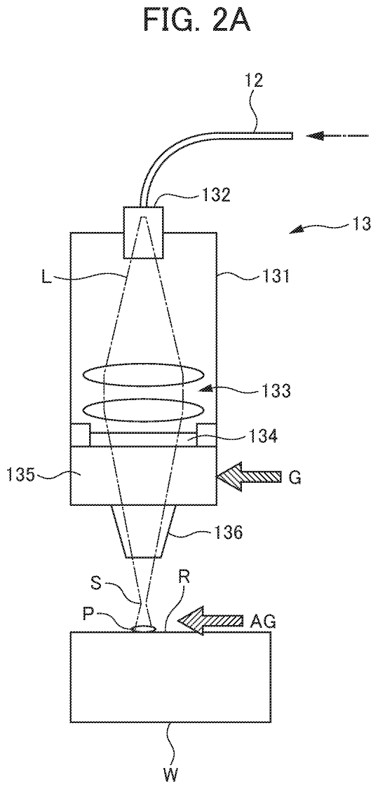

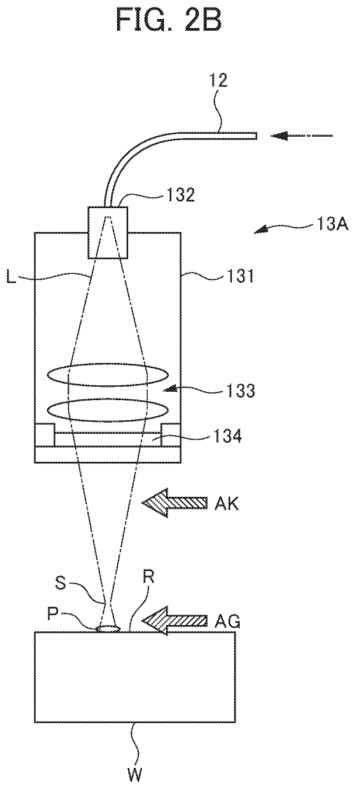

Here, FIG. 2A is a side view showing the configuration of the laser machining head 13 in the deburring device 1 according to the present embodiment. As shown in FIG. 2A, the laser machining head 13 includes a machining head main body 131, a light guide unit 132, a light focusing optical system 133, a protective window 134, an airtight chamber 135 and a contamination prevention nozzle 136.

The machining head main body 131 forms the housing of the laser machining head 13, and stores the light focusing optical system 133 which will be described later and the like therewithin. The laser light L which is guided from the laser source 11 through the light guide optical fiber 12 is guided into the machining head main body 131. Although the machining head main body 131 of the present embodiment is cylindrical, the shape of the machining head main body 131 is not limited to this shape.

The light guide optical fiber 12 described above is connected to the light guide unit 132. The light guide unit 132 is provided at the base end of the cylindrical machining head main body 131. The laser light L is guided from the light guide unit 132 to the light focusing optical system 133 within the machining head main body 131.

The light focusing optical system 133 is stored within the machining head main body 131 described above, and is formed with optical parts such as a lens, a curved mirror, a prism and a diffraction grating. The light focusing optical system 133 uses these optical parts so as to apply the laser light L to the workpiece W as spot light which has a desired light energy shape. Although a light focus point S which is the minimum spot is often arranged on the surface of the workpiece W, in order for a different machining result to be expected, the light focus point S may be arranged in a position displaced forward or backward from a machining point in the direction of a laser optical axis. FIG. 2A shows example where the light focus point S is arranged upward (the side of the laser machining head 13) from the machining point P on the ridgeline R of the workpiece W. It is possible to take various forms such as a form in which the laser optical axis is rotated or reciprocated at high speed, a form in which the laser optical axis is inclined, forward, backward, leftward or rightward, and, a form in which plurality of the laser light L are applied to the vicinity of the machining point P.

Since the machining point P at which laser machining is performed has a high temperature, the molten workpiece, the crushed workpiece, the vapors thereof, dust reacting with the surrounding gases and the like are produced so as to be scattered. Hence, in the laser machining head 13 of the present embodiment, in order to protect the light focusing optical system 133, the protective window 134, the airtight chamber 135 and the contamination prevention nozzle 136 are provided.

The protective window 134 is arranged in a boundary between the light focusing optical system 133 described above and the airtight chamber 135 which will be described later. The airtight chamber 135 is a chamber which is arranged at a tip of the machining head main body 131 and which is airtight, and a pressure within the airtight chamber is set to, for example, 0.0025 MPa. By utilization of a gas supply machine 23 and the like in the gas jetting device 20 which will be described later, a gas G such as air is introduced from the outside into the airtight chamber 135, and thus it is possible to more reduce the flow of the molten material, the crushed material and the gases such as vapors from the machining point P into the light focusing optical system 133. The contamination prevention nozzle 136 is arranged at a tip of the airtight chamber 135, and thus it is possible to more reduce the flow of the molten material, the crushed material and the gases such as vapors from the machining point P into the light focusing optical system 133. The diameter of the hole of the contamination prevention nozzle 136 is set to, for example, φ1 to 5 mm, and a distance between the contamination prevention nozzle 136 and the workpiece W is set to, for example, 25 mm.

Here, FIG. 2B is a side view showing the configuration of a laser machining head 13A in a deburring device according to a variation of the present embodiment. The laser machining head 13A of the variation differs from the laser machining head 13 described above in that the airtight chamber 135 and the contamination prevention nozzle 136 are not included. Instead, in order to protect the light focusing optical system 133, a high-speed air flow (air knife) AK is generated between the machining point P (in the vicinity of the light focus point S) and the light focusing optical system 133, with the result that the laser machining head 13A reduces the contamination of the light focusing optical system 133.

The air knife AK is generated with air blown out by utilization of the gas supply machine 23 and the like in the gas jetting device 20 which will be described later. The width of the air knife AK is set to, for example, 40 mm, and the air knife AK is generated by blowing out air from a jetting slit whose width is 0.5 mm or the like at a flow rate of 200 L/minute.

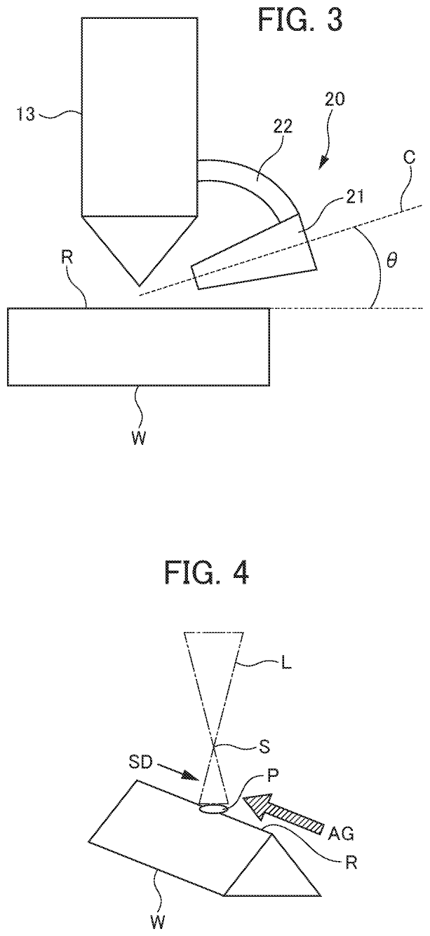

FIG. 3 is a side view showing the configuration of the gas jetting device 20 in the deburring device 1 according to the present embodiment. The gas jetting device 20 jets an assist gas AG such as air to the vicinity of the machining point P to which the laser light is applied. As shown in FIGS. 1 to 3, the gas jetting device 20 includes a gas jetting nozzle 21, an angle adjustment arm 22 and the gas supply machine 23.

The gas jetting nozzle 21 is a tapered cylindrical nozzle, and is connected to the gas supply machine 23. The gas jetting nozzle 21 is arranged such that the assist gas AG is jetted from a forward side in a scanning direction toward the vicinity of the machining point P to which the laser light IL is applied. The supply and the jetting of the assist gas AG with the gas jetting nozzle 21 and the gas supply machine 23 are controlled by the controller 40.

For example, when it is desired to prevent, as much as possible, the molten material and the crushed material from the machining point P from being adhered to portions after being subjected to deburring machining or when the workpiece W and the laser machining head 13 are brought into contact such as by presence of a recess portion in the ridge line R, the assist gas AG may be jetted from a backward side in the scanning direction.

The angle adjustment arm 22 is attached to the laser machining head 13 so as to adjust the angle of the gas jetting nozzle 21 with respect to the workpiece W. The angle adjustment arm 22 is controlled by the controller 40 which will be described later.

As shown in FIG. 1, the gas supply machine 23 includes an air source 231, a gas source 232 and a solenoid valve and an electropneumatic regulator 233. They are controlled by the controller 40 which will be described later so as to be able to supply a gas such as air or an inert gas.

The present embodiment is characterized in the position of jetting of the assist gas AG with the gas jetting nozzle 21, and thus it is possible to perform stable deburring machining. The position of jetting of the assist gas AG with the gas jetting nozzle 21 will be described in detail later.

In the present embodiment, as shown in FIG. 3, in order for the workpiece W and the gas jetting nozzle 21 to be prevented from being, brought into contact and interfering with each other, the gas jetting nozzle 21 is arranged slightly upward with respect to the ridge line R of the workpiece W. As will be described later, the gas letting nozzle 21 arranged to be inclined obliquely backward.

The transport device 30 transports the laser device 10 and the gas jetting device described above. In this way, the laser machining head 13 and the gas jetting nozzle 21 can be relatively moved with respect to the workpiece W. Although as the transport device 30, for example, as shown in FIG. 1, a multi-joint robot is used, there is no limitation to this configuration. A three-axis or five-axis numerically controlled machine tool can be used, and a carriage which is simply mowed in one direction can also be used.

The controller 40 controls the laser device 10, the gas jetting device 20 and the transport device 30. Specifically, the controller 40 controls timing at which the laser light L is applied with the laser device 10, the output thereof, the position of the application and the like. The controller 40 also controls timing, at which the assist gas AG is jetted with the gas jetting device 20, the flow rate of the jetting, the position of the jetting and the like. The controller 40 also controls the transport of the laser machining head 13 and the gas jetting nozzle 21 with the transport device 30. The controller 40 is realized, for example, by making a computer including a CPU, a memory and the like read programs related to the present embodiment.

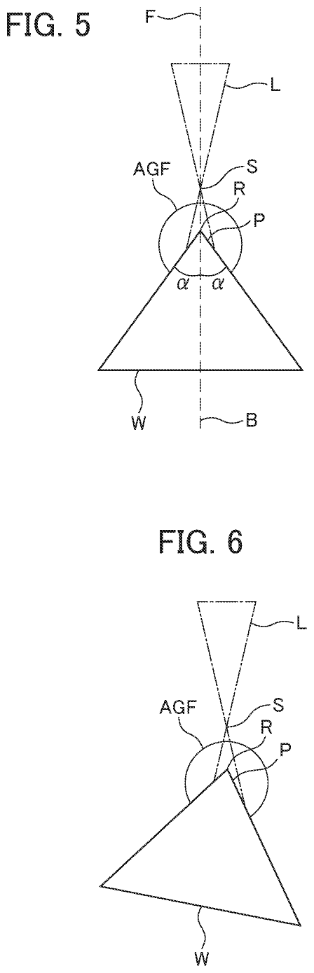

The operation of the de burring device 1 controlled by the controller 40 will be described in detail with reference to FIGS. 4 to 6. FIG. 4 is a perspective view showing laser application using the deburring device 1 according to the present embodiment. FIGS. 5 and 6 are front views (diagrams when the machining point P is seen from the forward side in the scanning direction) showing the laser application using the deburring device 1 according to the present embodiment, FIG. 5 shows a case where the geometric relationship of the workpiece W with the laser light L and the gas jetting nozzle 21 is maintained and FIG. 6 shows a case where the geometric relationship of the workpiece W (three-dimensional shape) with the laser light L and the gas jetting nozzle 21 is not maintained.

As shown the transport of the laser machining head 13 is controlled such that the laser light L applied from the laser machining head 13 is moved on the ridge line R (machining point P) of the workpiece W in the scanning direction SD according to a machining program generated in accordance with the shape of the workpiece. At the same time, the application of the laser light L to the ridge, line R (machining point P) is controlled, and the scanning using the laser light L is performed. In this way, burrs present on the ridge line R are removed.

Here, the transport is controlled such that the gas jetting nozzle 21 is moved on the ridge line R (machining point P) in the scanning direction SD. At the same time, the gas supply machine 23 and the angle adjustment arm 22 are controlled such that the assist gas AG from the gas jetting nozzle 21 is jetted from the forward side in the scanning direction SD toward the vicinity of the machining point P. In this way, the molten material of the burrs, the vapors, the crushed pieces and the like generated at the machining point P by the application of the laser light L are removed.

The position of jetting of the assist gas AG with the gas jetting nozzle 21 which is characterized in the present embodiment will then be described in detail. First, as shown in FIG. 5, in the deburring device 1 according to the present embodiment, the transport is controlled such that the gas jetting nozzle 21 is moved on a plane F (in FIG. 5, a plane perpendicular to the plane of FIG. 5) including the bisector B of an apex angle of the ridge line R (in FIG. 5, a line segment which divides the apex angle into two equal angles α) and the ridge line R. In this way, as shown in FIG. 5, the gas flow AGF of the assist gas AG jetted from the gas jetting nozzle 21 flows substantially parallel to the ridge line R, and thus the disturbance of the gas flow AGF in the vicinity of the machining point P on the ridge line R is reduced, with the result that the assist gas AG stably flows.

As shown in FIG. 3, in the deburring device 1 according to the present embodiment, the transport is controlled while the gas jetting nozzle 21 is being retained such that in a side view parallel to the ridge line R of the workpiece W, an angle θ formed by the central axis line C of the gas jetting nozzle 21 and the ridge line R is an acute angle. In this way, the gas flow AGF f the assist gas AG jetted from the gas jetting nozzle 21 easily flows substantially parallel to the ridge line R, and thus the disturbance of the gas flow AGF in the vicinity of the machining point P on the ridge line R is more reduced, with the result that the assist gas AG more stably flows.

Hence, even when as shown in FIG. 6, in the deburring device 1 according to the present embodiment, for some reason, the geometric relationship of the workpiece W (three-dimensional shape) with the laser light L and the gas jetting nozzle 21 is not maintained, substantially parallel positional relationship between the dose line R and the flow of the assist gas AG is retained. Thus, the disturbance of the gas flow AGF of the assist gas AG in the vicinity of the machining point P resulting from a change in the gas flow AGF is reduced.

In the present embodiment, in a side view parallel to the ridge line R , the angle θ formed by the ridge line R and the central axis line C of the gas jetting nozzle 21 is preferably equal to or less than 22.5 degrees. In this way, the more stable assist gas AG is supplied.

Hence, in the deburring device 1 according to the present embodiment, the following effects are achieved.

(1) In the present embodiment, in the deburring device 1 for removing burrs which are present on the ridge line R of the workpiece W (three-dimensional shape) after being machined, the laser device 10 which includes the laser machining head 13 that applies the laser light L to the ridge line of the workpiece W, the gas jetting device 20 which includes the gas jetting nozzle 21 that jets the assist gas AG, the transport device 30 which transports the laser device 10 and the gas jetting device 20 and the controller 40 which controls the laser device 10, the gas jetting device 20 and the transport device 30 are provided. Then, the controller 40 controls the gas jetting device 20 and the transport device 30 such that the gas jetting nozzle 21 is moved on the plane F including the bisector B of the apex angle of the ridge line R and the ridge line R and that in a side view parallel to the ridge line R, the angle θ formed by the ridge line and the central axis line C of the gas jetting nozzle 21 is an acute angle. In this way, even when the geometric relationship of the workpiece W (three-dimensional shape) with the laser light L and the gas jetting nozzle 21 is not maintained, a substantially parallel positional relationship between the ridge line R and the gas flow AGF of the assist gas AG can be retained, with the result that it is possible to reduce the disturbance of the gas flow AE of the assist gas AG in the vicinity of the machining point P resulting from a change in the gas flow AGF. Hence, it is possible to perform the stable deburring machining.

(2) In the present embodiment, the controller 40 controls the gas jetting device 20 and the transport device 30 such that in a side view parallel to the ridge line R, the angle θ formed by the ridge line R and the central axis line G of the gas jetting nozzle 21 is equal to or less than 22.5 degrees. In this way, it is possible to more reliably retain a substantially parallel positional relationship between the ridge line R and the flow of the assist gas AG, and thus it is possible to reduce the disturbance of the gas flow AGF of the assist gas AG in the vicinity of the machining point P resulting from a change in the gas flow AGF. Hence, it is possible co perform the more stable deburring machining.

### Second Embodiment

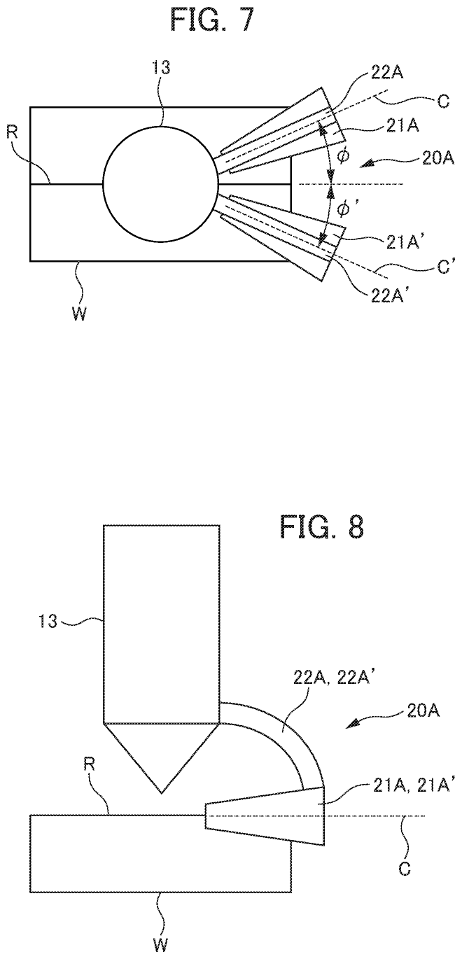

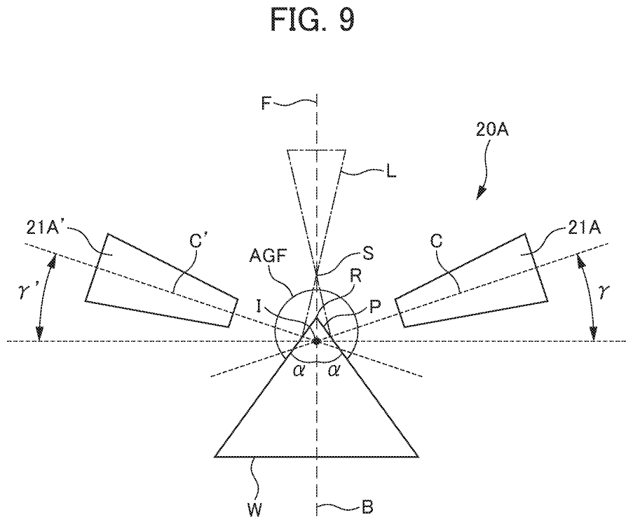

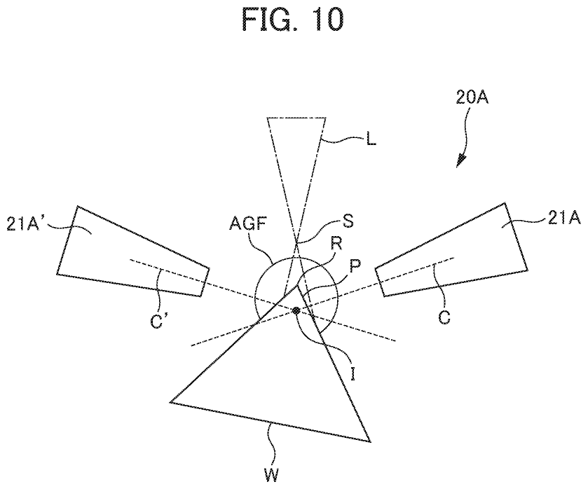

A deburring device according to the second embodiment has the same configuration as the deburring device according to the first embodiment except that the deburring device according to the second embodiment includes a pair of gas jetting nozzles and a pair of angle adjustment arms and that the arrangement of the pair of gas jetting nozzles is different from the first embodiment. FIG. 7 is a plan view showing the configuration of a gas getting device 20A in the deburring device according to the present embodiment. FIG. 8 is a side view showing the configuration of the gas jetting device 20A in the deburring device according to the present embodiment. FIGS. 9 and 10 are front views (diagrams when the machining point a is seen from the forward side in the scanning direction) showing laser application using the deburring device according to the present embodiment, FIG. 9 shows a case where the geometric relationship of the workpiece W with the laser light L and the gas jetting nozzles 21A and 21A′ is maintained and FIG. 10 shows a case where the geometric relationship of the workpiece W (three-dimensional shape) with the laser light L and the gas jetting nozzles 21A and 21A′ is not maintained.

As shown in FIGS. 7 to 9, the deburring device according to the present embodiment includes the pair of gas jetting nozzles 21A and 21A′ and the pair of angle adjustment arms 22A and 22A′. The configurations of the gas jetting nozzles 21A and 21A′ themselves are the same as the configuration of the gas jetting nozzle 21 in the first embodiment. The configurations of the angle adjustment arms 22A and 22A′ themselves are the same as the configuration of the angle adjustment arm 22 in the first embodiment.

As shown in FIG. 7, gale pair of gas jetting nozzles 21A and 21A′ each are arranged such that the tips thereof are directed to the vicinity of the machining point P. More specifically, the pair of gas jetting nozzles 21A and 21A′ are arranged such that they are closer to each other toward the sides of the tips and that they are farther from each other toward the sides of the base ends. In the plan view of FIG. 7, angles φ and φ′ formed by the ridge line R and the central axis lines C and C′ of the gas jetting nozzles 21A and 21A′ are preferably equal to or less than 45 degrees. When the angles φ and φ′ are equal to or less than 45 degrees, the disturbance of the gas flow AGF of the assist gas AG is reduced.

Unlike the first embodiment, the pair of gas jetting nozzles 21A and 21A′ are arranged not directly on the ridge line R of the workpiece W but positions displaced laterally from the ridge line R. Hence, it is possible to prevent the pair of gas jetting nozzles 21A and 21A′ and the vicinity of the ridge line R of the workpiece W from interfering with each other, and thus in a side view parallel to the ridge line R as shown in FIG. 8, the pair of gas jetting nozzles 21A and 21A′ can be arranged such that the central axis lines C and C′ thereof and the ridge line R are parallel to each other and that furthermore, the positions of the heights thereof substantially coincide with each other. In other words, in a side view parallel to the ridge line R, each of the angles θ and θ′ (not shown) formed by the ridge line R and the central axis lines C and C′ of the as jetting nozzles 21A and 21A′ can be set to zero degrees. This will be described in detail later.

The position of jetting of the assist gas AG with the gas jetting nozzles 21A and 21A′ which is characterized the present embodiment will then be described in detail. As shown in FIG. 9, in the present embodiment, the transport of the pair of gas jetting nozzles 21A and 21A′ is controlled such that the gas jetting nozzles 21A and 21A′ are moved while positions symmetrical to each other with respect to a plane F (in FIG. 9, a plane perpendicular to the plane of FIG. 9) including the bisector B of an apex angle of the ridge line (in FIG. 9, a line segment which divides the apex angle into two equal angles α) and the ridge line R are being retained. In this way, as shown in FIG. 9, the gas flows AGF of the assist gas AG jetted from the gas jetting nozzles 21A and 21A′ are evenly supplied from both sides of the ridge line R, and thus the disturbance of the gas flow AGF in the vicinity of the machining point P on the ridge line R is reduced, with the result that the assist gas AG stably flows. FIG. 9 shows an example where each of the angles θ and θ′ (not shown) formed by the ridge line R and the central axis lines C and C′ of the gas jetting nozzles 21A and 21A″ is set larger than zero degrees. Hence, in the front view of FIG. 9, angles [symbol] and [symbol] formed by the ridge line and the central lines C and C′ of the gas jetting nozzles 21A and 21A′ are also larger than zero degrees.

In the present embodiment, as in the first embodiment, the transport is controlled while the pair of gas jetting side nozzles 21A and 21A′ are being retained such that in view parallel to the ridge line R, the angles θ and θ′ (not shown) formed by the ridge line R and the central axis lines C and C′ of the pair of gas jetting nozzles 21A and 21A′ are acute angles. In this way, the gas flows AGF or the assist gas AG jetted from the gas jetting nozzles 21A and 21A′ easily flow substantially parallel to the ridge line R, and thus the disturbance of the gas flow AGF in the vicinity of the machining point P on the ridge line R is more reduced, with the result that the assist gas AG more stably flows.

Hence, even when as shown in FIG. 10, in the de burring device according D the present embodiment, for some reason, the geometric relationship of the workpiece W (three-dimensional shape) with the laser light L and the gas jetting nozzles 21A and 21A′ is not maintained, a substantially parallel positional relationship between the ridge line R and the gas flow AGF of the assist gas AG is retained. Thus, the disturbance of the flow of the assist gas AG in the vicinity of the machining point P resulting from a change in the flow thereof is reduced.

Preferably, as shown FIG. 8, in the present embodiment, the transport is controlled while the pair of gas jetting nozzles 21A and 21A′ are being retained such that in a side view parallel to the ridge line R, the angles θ and θ′ (not shown) formed by the ridge line R and the central axis lines C and C′ of the pair of gas jetting nozzles 21A and 21A′ are substantially zero degrees, that that in the side view, the ridge line R and the central axis lines C and C′ coincide with each other. In this way, the assist gas AG flows parallel to the ridge line R, and thus the more stable assist gas AG is supplied.

More preferably as shown in FIG. 9, in the present embodiment, the transport is controlled such that the intersection I of the central axis lines C and C′ of the pair of gas jetting nozzles 21A and 21A′ is located within the workpiece W (three-dimensional shape). In this way, the main flows of the assist gas AG hit the workpiece W, and thus the influence of the geometric relationship is more unlikely to be received. In other words, the main flows of the assist gas AG supplied from both sides of the ridge line R are prevented from being combined together in space, and thus the disturbance of the gas flow AGF of the assist gas AG resulting from a change it the gas flow AGF is more reduced.

Hence, in the deburring device according to the present embodiment, the following effects are achieved.

(3) In the present embodiment, in the deburring device for removing burrs which are present on the ridge line R of the workpiece W after being machined, the laser device 10 which includes the laser machining head 13 that applies the laser light L to the ridge line R of the workpiece W, the gas jetting device 20 which includes the pair of gas jetting nozzles 21A and 21A′ that jet the assist gas AG, the transport device 30 which transports the laser device 10 and the gas jetting device 20 and the controller 40 which controls the laser device 10, the gas jetting device 20 and the transport device 30 are provided. Then, the controller 40 controls the gas jetting device 20 and the transport device such that the pair of gas jetting nozzles 21A and 21A′ are moved while the positions symmetrical to each other with respect to the plane F including the bisector B of the apex angle of the ridge line R and the ridge line R are being retained and that in a side view parallel to the ridge line R, the angles θ and θ′ (not shown) formed by the ridge line R and the central axis lines C and C′ of the pair of gas jetting nozzles 21A and 21A′ are acute angles. In this way, even when the geometric relationship of the workpiece W (three-dimensional shape) with the laser light L and the gas jetting nozzles 21A and 21A′ is not maintained, since the assist gas AG can be supplied from both sides of the ridge line R, it is possible to reduce the disturbance of the gas flow AGF of the assist gas in the vicinity of the machining point P resulting from a change in the gas flow AGF. Hence, it is possible to perform the stable deburring machining.

(4) In the present embodiment, the controller 40 controls the gas jetting device 20 and the transport device 30 such that in a side view parallel to the ridge line R, the angles θ and θ′ (not shown) formed by the ridge line R and the central axis lines C and C′ of the pair of gas jetting nozzles 21A and 21A′ are substantially zero degrees. In this way, the assist gas AG can be made to flow parallel to the ridge line R, and thus is possible to more reduce the disturbance of the gas flow AGF of the assist gas resulting from change in the gas flow AGF. Hence, it is possible to perform the more stable deburring machining.

(5) In the present embodiment, the controller 40 controls the gas jetting device 20 and the transport device 30 such that in a plan view parallel to the ridge line , the angles and formed by the ridge line R and the central axis lines C and φ′ of the pair of gas jetting nozzles 21A and 21A′ are equal to or less than 45 degrees. In this way, it s possible to reduce an unstable flow resulting from the two gas flows facing each other, and thus it is possible to more reduce the disturbance of the gas flow AGF of the assist gas resulting from a change in the gas flow AGF. Hence, it is possible to perform the more stable deburring machining.

(6) In the present embodiment, the controller 40 controls the gas jetting device 20 and the transport device 30 such that the intersection I of the central axis lines C and C′ of the pair of gas jetting nozzles 21A and 21A′ is located within the workpiece W. In this way, the main flows of the assist gas AG hit the workpiece W (three-dimensional shape), and thus the influence of the geometric relationship is more unlikely to be received. In other words, the main flows of the assist gas AG arranged symmetrically with respect to the plane are prevented from being combined together in space, and thus the disturbance of the gas flow AGF of the assist gas AG resulting from a change in the gas flow AGF is more reduced. Hence, it is possible to perform the more stable deburring machining.

The present invention is not limited to the embodiments described above, and includes variations and modifications as long as the object of the present invention can be achieved.

### EXAMPLES

### Example 1

The deburring device 1 according to the first embodiment was used, and thus deburring machining was performed on the ridge line of a workpiece. Specifically, a fiber laser having a wavelength of 1070 nm was utilized, and as the workpiece, carbon steel S50C on which milling had been performed was used. The maximum height of burrs in the carbon steel S50C was 0.5 mm.

On the carbon steel S50C, the deburring machining was performed under conditions in which the diameter of a laser emitting end fiber core was 50 μm, in which an optical magnification was 1.5 times, in which a distance from a spot to a machining point was 23.2 mm, which the diameter of a beam at the machining point was about 1000 μm, in which a laser output was 230 W, in which a scanning speed was 300 mm/minute, in which the diameter of a gas jetting nozzle for an assist gas was φ6 mm, which a flow rate was 50 L/minute, in which a distance between a member of the gas jetting nozzle for the assist gas and the ridge line was 3 mm and in which an angle θ between the central axis line of the nozzle and the ridge line was 10 degrees.

Consequently, burrs and the ridge line of an acute angle were melted, and were molded so as to be rounded with a radius of 0.3 mm. Hence, it has been confirmed that with the deburring device according to the first embodiment, it is possible to perform stable deburring machining.

Although in a side view, an angle θ formed by the ridge line and the central axis line of the gas jetting nozzle is preferably minimized, when as in Example 1, one gas jetting nozzle for the assist gas is provided, a certain degree of angle is needed in order to prevent this gas jetting nozzle from making contact with the ridge line. In the result of the experiment, in the case of the carbon steel S50 C, when the angle θ formed by the central axis line of the nozzle and the ridge line exceeded 22.5 degrees, an adverse effect caused by the large angle θ was confirmed. It has been confirmed from the experimental example that when the angle θ is large and the machining point and the center of the assist gas flow do not coincide with each other, it is significantly difficult to remove a molten material and a crushed material.

### Example 2

The deburring device according to the second embodiment was used, and thus deburring machining was performed on the ridge line of a workpiece. Specifically, the deburring machining was performed both when the intersection of the central axis lines of two gas jetting nozzles for an assist gas was arranged on the ridge line and when the intersect on was arranged 1 mm below the ridge line. The deburring machining was performed under the same conditions as in Example 1 except that as an angle formed by the ridge line and each of the central axis lines, in a side view, θ=zero degrees and in a plan view, φ=30 degrees (hence, in a front view, γ=zero degrees) and that each of flow rates was 30 L/minute.

Consequently, in each of the cases, burrs and the ridge line of an acute angle were melted, and were molded so as to be rounded with a radius of 0.3 mm. In this way, it has been confirmed that with the deburring device according to the second embodiment, it is possible to perform stable deburring machining.

Although in a plan view, an angle φ formed by the ridge line and each of the central axis lines of the gas jetting nozzles is preferably minimized, as a result of this experiment, almost no influence was exerted until φ=45 degrees. When this angle is large, and an angle at which two gas flows intersect each other exceeds 2×φ=90 degrees, that is, a right angle, the two gas flows face each other so as to be unstable. These are points to be noted in practicing the present invention.

### EXPLANATION OF REFERENCE NUMERALS

1 deburring device
10 laser device
13 laser machining head
20 gas jetting device
21, 21A, 21A′ gas jetting nozzle
30 transport device
40 controller
W workpiece
R ridge line
L laser light
AG assist gas
B bisector
C, C′ central axis line
F plane including bisector and ridge line
θ, θ′ angle formed by ridge line and central axis line of gas jetting nozzle in side view
φ, φ′ angle formed by ridge line and central axis line of gas jetting nozzle in plan view

[symbol] , [symbol] ′ angle formed by ridge line and central axis line of gas jetting nozzle in front view

I intersection

What claimed is:

1. A deburring device for removing a burr which is present on a three-dimensionally shaped ridge line after being machined, the deburring device comprising:
a laser device which includes a laser machining head that applies laser light to the three-dimensionally shaped ridge line;
a gas jetting device which includes a gas jetting nozzle that jets an assist gas;
a transport device which transports the laser device and the gas jetting device; and
a controller which controls the laser device, the gas jetting device and the transport device,
wherein the controller controls the gas jetting device and the transport device such that the gas jetting nozzle is moved on a plane including, a bisector of an apex angle of the ridge line and the ridge line and that in a side view parallel to the ridge line, an angle formed by the ridge line and a central axis line of the gas nozzle is an acute angle.

2. The deburring device according to claim 1, wherein the controller controls the gas jetting device and the transport device such that in a side view parallel to the ridge line, the angle formed by the ridge line and the central axis line of the gas jetting nozzle is equal to or less than 22.5 degrees.

3. A deburring device for removing a burr which is present on a three-dimensionally shaped ridge line after being machined, the deburring device comprising:
a laser device which includes a laser machining head that applies laser light to the three-dimensionally shaped ridge line;
a gas jetting device which includes a pair of gas jetting nozzles that jet an assist gas;
a transport device which transports the laser device and the gas jetting device; and
a controller which controls the laser device, the gas jetting device and the transport device,
wherein the controller controls the gas jetting device and the transport device such that the pair of gas jetting nozzles are moved while positions symmetrical to each other with respect to a plane including a bisector of an apex angle of the ridge line and the ridge line are being retained and that in a side view parallel to the ridge line, angles formed by the ridge line and central axis lines of the pair of gas jetting nozzles are acute angles.

4. The deburring device according to claim 3, wherein the controller controls the gas jetting device and the transport device such that in a side view parallel to the ridge line, the angles formed by the ridge line and the central axis lines of the pair of gas jetting nozzles are substantially zero degrees.

5. The debarring device according to claim 3, wherein the controller controls the gas jetting device and the transport device such that in a plan view parallel to the ridge line, angles formed by the ridge line and the central axis lines of the pair of gas jetting nozzles are equal to or less than 45 degrees.

6. The debarring device according to claim 4, wherein the controller controls the gas jetting device and the transport device such that in a plan view parallel to the ridge line, angles formed by the ridge line and the central axis lines of the pair of gas jetting nozzles are equal to or less than 45 degrees.

7. The deburring device according to claim 3, wherein the controller controls the gas jetting device and the transport device such that an intersection of the central axis lines of the pair of gas jetting nozzles is located within the three-dimensional shape.

8. The deburring device according to claim 4, wherein the controller controls the gas jetting device and the transport device such that an intersection of the central axis lines of the pair of gas jetting nozzles is located within the three-dimensional shape.

9. The deburring device according to claim 5, wherein the controller controls the gas jetting device and the transport device such that an intersection of the central axis lines of the pair of gas jetting nozzles is located within the three-dimensional shape.

10. The deburring device according to claim 6, wherein the controller controls the gas jetting device and the transport device such that an intersection of the central axis lines of the pair of gas jetting nozzles is located within the three-dimensional shape.
